(19) United States
(12) Patent Application Publication
(10) Pub. No.: US 2010/0056740 A1
(43) Pub. Date: Mar. 4, 2010

(54) ADSORPTION-RESISTANT ACRYLIC COPOLYMER FOR FLUIDIC DEVICES

(75) Inventors: Jikun Liu, Greenbelt, MD (US); Xuefei Sun, Provo, UT (US); Milton L. Lee, Pleasant Grove, UT (US)

Correspondence Address: JAMES SONNTAG;JAMES SONNTAG, PATENT ATTORNEY, P.O. BOX 9194, SALT LAKE CITY, UT, 84109, US

(73) Assignee: BRIGHAM YOUNG UNIVERSITY, Provo, UT (US)

(21) Appl. No.: 12/304,738

(22) PCT Filed: Jun. 14, 2007
(86) PCT No.: PCT/US2007/071266

§ 371 Date: Mar. 23, 2009

Related U.S. Application Data
(60) Provisional application No. 60/813,884, filed on Jun. 14, 2006.

(51) Int. Cl. C08F 220/26; B05D 3/10; B05D 3/12

(52) U.S. Cl. 526/320; 216/83; 427/355

(57) ABSTRACT

A copolymer is used for fluidic devices that require surfaces nonreactive with biomolecules. The copolymer is the reaction product of Compound A having the formula:

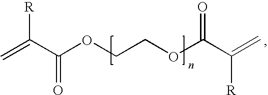

and Compound B having the formula

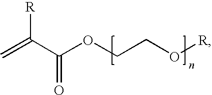

where the R groups are the same or different and are selected from hydrogen, and alkyl groups with 4 carbons or less,
where n is the same or different and is greater than 3.

### CROSS REFERENCE TO RELATED APPLICATIONS

This application claims priority from U.S. Provisional Patent Application 60/813,884, filed 14 Jun. 2006, and from International Application under the PCT, Application No. PCT/US07/71266, International Filing Date: 14 Jun. 2007, both of which are incorporated by reference.

### FEDERAL RESEARCH STATEMENT

This invention was made with support from United States Government, and the United States Government may have certain right in this invention pursuant to National Institutes of Health contract number R01 GM064547-01A1.

### BACKGROUND OF INVENTION

A variety of commercially available polymers including polydimethylsiloxane (PDMS),¹⁻³ poly(methyl methacrylate) (PMMA),⁴⁻⁶ polystyrene (PS),^{7,8} polycarbonate (PC),^{9,10} polyethylene terephthalate (PET/PETG),^{11,12} polyimide (PI),^{13,14} and polycycloolefin (PCOC, under the commercial name of Topas or Zeonex/Zeonor),¹⁵⁻¹⁷ have been investigated for the fabrication of microfluidic devices. Compared to inorganic materials such as glass, silicon, and quartz, polymeric materials are inexpensive and easier to micromachine, which makes mass production of disposable microfluidic devices more feasible.

Unfortunately, adsorption of biomolecules such as proteins on channel walls is a common problem for microfluidic devices fabricated from almost any material, including polymeric materials, which results in sample loss and deterioration in separation performance. To minimize protein adsorption, the surface must be passivated. Currently, two categories of methods, dynamic coating and permanent surface modification, are used to passivate polymer surfaces. Although dynamic coating is more convenient to perform (i.e., surface modifiers are typically added to the separation buffer), it is not permanent and analytes can compete for active sites on the surface. Dynamic surface modifiers can be detrimental in applications that require coupling to a mass spectrometer or a miniaturized chemical reactor. Moreover, caution must be taken to prevent denaturing or even destruction of protein-based analytes by surface modifiers. Therefore, permanent surface modification is preferred.

To permanently attach protein-resistant functional groups on a polymeric channel surface, first, relatively harsh chemical reactions or high-energy sources, including light irradiation, flame, corona, plasma, electron beam or ion beam, must be used to activate the polymer surface.^{18,19.} Following surface activation, protein adhesion-resistant polymers are covalently anchored to the surface.

Among the various materials evaluated for modifying surfaces for resistance to adsorption of proteins and peptides, polyethylene oxides have been particularly effective. Papra et al.²⁰ grafted 2-[methoxy(polyethyleneoxy)propyl]trimethoxysilane (MW˜460-590) and poly(ethyleneoxy) di(triethoxy)silane (MW˜3400) on oxygen plasma-treated PDMS substrates and found that the poly(ethylene glycol) (PEG) functionalized silanes improved the resistance of the substrates to TRITC-labeled IgG. To prevent protein adsorption, Wang et al.²¹ used an oxygen plasma to activate a PDMS microchannel surface and 3-methacryloxypropyl trimethoxysilane was grafted to the surface. Next, polyacrylamide (PAAm) was immobilized on the methacryl layer by introducing a monomer solution containing acrylamide, ammonium persulfate and tetramethylethylenediamine. To further increase the protein resistance, methylcellulose was dynamically coated onto the polyacrylamide-grafted microchannel. It was mentioned that microchannels treated according to this protocol had better resistance to protein adsorption than those only dynamically coated with methylcellulose.

Hu et al.^{22,23} photografted a copolymer of poly(ethylene glycol) monomethoxyl acrylate, acrylic acid, and poly(ethylene glycol) diacrylate onto the surface of a PDMS microcapillary electrophoresis (μCE) chip, and separated various peptides. Using a similar method, Li et al.²⁴ grafted PAAm on the surface of a PCOC microisoelectric focusing device, which was used to separate conalbumin and β-lactoglobulin A. Huang et al.²⁵ reacted 1-trichlorosilyl-2-(m-p-chloromethylphenyl)ethane on a UV/O₃-oxidized PDMS microchannel surface via silanization, and introduced an aqueous reaction solution containing acrylamide, CuCl, CuCl₂, and tris(2-dimethylaminoethyl)amine into the channel under the protection of an argon atmosphere. Ten hours later, PAAm was grafted on the channel surface through atom-transfer radical polymerization (ATRP). Electrophoretic separation of TRITC-labeled lysozyme and cytochrome c was demonstrated using the PAAm-grafted microchip. Recently, ATRP was employed to graft PEG on activated PMMA and poly(glycidyl methacrylate)-co-(methyl methacrylate) (PGMAMMA) channel surfaces, and high-quality electrophoretic protein and peptide separations were obtained using both PMMA and PGMAMMA capillary electrophoresis microdevices.^{26,27}

Unfortunately, permanent surface modification requires tedious multi-step physical/chemical processing, which complicates the preparation of polymeric microfluidic devices. The most desirable solution to this problem is to develop new polymeric materials that possess inherent protein resistance and good physical properties, which can be used to fabricate microfluidic devices without further surface modification.

Many researchers have already started to employ novel polymeric materials synthesized from monomers or prepolymers in microfabrication. Using a photolithographic fabrication method (microfluidic tectonics), Beebe et al.²⁸ constructed microfluidic platforms with various geometries from liquid prepolymers containing isobornyl acrylate, 2,2-bis[p-(2′-hydroxy-3′-methacryloxypropoxy)phenylene]propane or tetraethyleneglycol dimethacrylate. To modify the surface properties of PMMA microchannels, Wang et al.²⁹ doped the primary methyl methacrylate monomer with methacrylic acid, 2-sulfoethyl-methacrylate, and 2-aminoethyl-methacrylate during atmospheric-pressure molding process. Fiorini et al.³⁰ fabricated thermoset polyester microfluidic devices using a casting method resembling soft lithography.³¹ Rolland et al.³² employed soft lithography³¹ to fabricate solvent-resistant microfluidic devices with photocurable perfluoropolyethers. Sudarsan et al.³³ prepared thermalplastic elastomer gels by combining polystyrene-(polyethylene/polybutylene)-polystyrene triblock copolymers with a hydrocarbon extender oil. Interestingly, both hot embossing and soft lithography³¹ can be used for this polymeric material. Cabodi et al.³⁴ utilized soft lithography³¹ to construct microfluidic network with calcium alginate, a biocompatible hydrogel. Asthana et al.³⁵ fabricated various microstructures with poly(vinyl silazane). Again, soft lithography³¹ was employed in the fabrication. Using contact liquid photolithographic polymerization, a microfabrication approach exploiting living radical photopolymerization chemistry, Hutchison et al.³⁶ fabricated polymeric microfluidic devices containing various photocurable vinyl-containing monomers.

PGMAMMA sheets have been synthesized via thermal polymerization and used to fabricate PGMAMMA capillary electrophoresis microchips using hot embossing.²⁷ In comparison to the commercially available polymers, the synthesized polymeric materials reported so far cannot be used directly without a synthesis process, which in most cases is in combination with microfabrication process. Additionally, soft lithography³¹ is dominantly used as fabrication method because of its simplicity and versatility. It should be mentioned, however, that most synthesized materials cannot be used for protein and peptide analysis without appropriate surface treatment. Fortunately, the properties of the synthesized polymers can be easily tailored by adjusting the contents of monomers or prepolymers during the synthesis-fabrication process, and it is feasible to develop anti-biofouling polymers suitable for microfabrication following this strategy.

Kim et al.³⁷ reported a microfabrication process using PEG-functionalized crosslinkers. However, neat crosslinkers were used to synthesize the polymeric materials and there was no demonstration of any separation result.

### REFERENCES

1. Effenhauser, C. S.; Bruin, G. J. M.; Paulus, A.; Ehrat, M. Anal. Chem. 1997, 69, 3451-3457.
2. Duffy, D. C.; McDonald, J. C.; Schueller, O. J. A.; Whitesides, G. M. Anal. Chem. 1998, 70, 4974-4984.
3. McDonald, J. C.; Duffy, D. C.; Anderson, J. R.; Chiu, D. T.; Wu, H. K.; Schueller, O. J. A.; Whitesides, G. M. Electrophoresis 2000, 21, 27-40.
4. Nagata, H.; Tabuchi, M.; Hirano, K.; Baba, Y. Electrophoresis 2005, 26, 2687-2691.
5. Chen, Y.-H.; Chen, S.-H. Electrophoresis 2000, 21, 165-170.
6. Meng, Z.; Qi, S.; Soper, S. A.; Limbach, P. A. Anal. Chem. 2001, 73, 1286-1291.
7. Barker, S. L. R.; Ross, D.; Tarlov, M. J.; Gaitan, M.; Locascio, L. E. Anal. Chem. 2000, 72, 5925-5929.
8. Barker, S. L. R.; Tarlov, M. J.; Canavan, H.; Hickman, J. J.; Locascio, L. E. Anal. Chem. 2000, 72, 4899-4903.
9. Liu, Y.; Ganser, D.; Schneider, A.; Liu, R.; Grodzinski, P.; Kroutchinina, N. Anal. Chem. 2001, 73, 4196-4201.
10. Vreeland, W. N.; Locascio, L. E. Anal. Chem. 2003, 75, 6906-6911.
11. Malmstadt, N.; Yager, P.; Hoffman, A. S.; Stayton, P. S. Anal. Chem. 2003, 75, 2943-2949.
12. Munce, N. R.; Li, J.; Herman, P. R.; Lilge, L. Anal. Chem. 2004, 76, 4983-4989.
13. Yin, H.; Killeen, K.; Brennen, R.; Sobek, D.; Werlich, M.; van de Goor, T. Anal. Chem. 2005, 77, 527-533.
14. Gobry, V.; Van Oostrum, J.; Martinelli, M.; Rohner, T. C.; Reymond, F.; Rossier, J. S.; Girault, H. H. Proteomics 2002, 2, 405-412.
15. Castaño-Álvarez, M.; Fernández-Abedul, M. T.; Costa-García, A.; Electrophoresis 2005, 26, 3160-3168.
16. Yang, Y.; Li, C.; Lee, K. H.; Craighead, H. G. Electrophoresis 2005, 26, 3622-3630.
17. Stachowiak, T. B.; Rohr T.; Hilder, E. F.; Peterson, D. S.; Yi, M.; Svec, F.; Fréchet, J. M. J. Electrophoresis 2003, 24, 3689-3693.
18. Garbassi, F.; Morra, M.; Occhiello, E. Polymer Surfaces: From Physics to Technology; John Wiley & Sons: Chichester, N.Y., 1998.
19. Jagur-Grodzinski, J. Heterogeneous Modification of Polymers: Matrix and Surface Reactions; John Wiley & Sons: Chichester, N.Y., 1997.
20. Papra, A.; Bernard, A.; Juncker, D.; Larsen, N. B.; Michel, B.; Delamarche, E. Langmuir 2001, 17, 4090-4095.
21. Wang, Y.-C.; Choi, M. H.; Han, J. Anal. Chem. 2004, 76, 4426-4431.
22. Hu, S.; Ren, X.; Bachman, M.; Sims, C. E.; Li, G. P.; Allbritton, N. Electrophoresis 2003, 24, 3679-3688.
23. Hu, S.; Ren, X.; Bachman, M.; Sims, C. E.; Li, G. P.; Allbritton, N. L. Anal. Chem. 2002, 74, 4117-4123.
24. Li, C.; Yang, Y.; Craighead, H. G.; Lee, K. H. Electrophoresis 2005, 26, 1800-1806.
25. Huang, X.; Doneski, L. J.; Wirth, M. J. Anal. Chem. 1998, 70, 4023-4029.
26. Liu, J.; Pan, T.; Woolley, A. T.; Lee, M. L. Anal. Chem. 2004, 76, 6948-6955.
27. Liu, J.; Sun, X.; Lee, M. L. Anal. Chem. 2005, 77, 6280-6287.
28. Beebe, D. J.; Moore, J. S.; Yu, Q.; Liu, R. H.; Kraft, M. L.; Jo, B.-H.; Devadoss, C. Proc. Natl. Acad. Sci. U.S.A. 2000, 97, 13488-13493.
29. Wang, J.; Muck, Jr., A.; Chatrathi, M. P.; Chen, G.; Mittal, N.; Spillman, S. D.; Obeidat, S. Lab Chip 2005, 5, 226-230.
30. Fiorini, G. S.; Lorenz, R. M.; Kuo, J. S.; Chiu, D. T. Anal. Chem. 2004, 76, 4697-4704.
31. Whitesides, G. M.; Ostuni, E.; Takayama, S.; Jiang, X. Y.; Ingber, D. E. Ann. Rev. Biomed. Eng. 2001, 3, 335-373.
32. Rolland, J. P.; Van Dam, R. M.; Schorzman, D. A.; Quake, S. R.; DeSimone, J. M. J. Am. Chem. Soc. 2004, 126, 2322-2323.
33. Sudarsan, A. P.; Wang, J.; Ugaz, V. M. Anal. Chem. 2005, 77, 5167-5173.
34. Cabodi, M.; Choi, N. W.; Gleghorn, J. P.; Lee, C. S. D.; Bonassar, L. J.; Stroock, A. D. J. Am. Chem. Soc. 2005, 127, 13788-13789.
35. Asthana, A.; Asthana, Y.; Sung, I.-K.; Kim, D.-P. Lab Chip 2006, 6, 1200-1204.
36. Hutchison, J. B.; Haraldsson, K. T.; Good, B. T.; Sebra, R. P.; Luo, N.; Anseth, K. S.; Bowman, C. N. Lab Chip 2004, 4, 658-662.
37. Kim, P.; Jeong, H. E.; Khademhosseinib, A.; Suh, K. Y. Lab Chip 2006, 6, 1432-1437.
38. Huang, X.; Gordon, M. J.; Zare, R. N. Anal. Chem. 1988, 60, 1837-1838.
39. Kelly, R. T.; Woolley, A. T. Anal. Chem. 2003, 75, 1941-1945.
40. Iki, N.; Yeung, E. S. J. Chromatogr. A 1996, 731, 273-282.
41. He, Y.; Yeung, E. S. J. Proteome. Res. 2002, 1, 273-277.
42. Zhao, Z.; Malik, A.; Lee, M. L. J. Microcol. Sep. 1992, 4, 411-417.
43. Zhao, Z.; Malik, A.; Lee, M. L. Anal. Chem. 1993, 65, 2747-2752.
44. Hjertén, S. J. Chromatogr. 1985, 347, 191-198.
45. Albarghouthi, M. N.; Stein, T. M.; Barron, A. E. Electrophoresis 2003, 24, 1166-1175.
46. Bousse, L.; Mouradian, S.; Minalla, A.; Yee, H.; Williams, K.; Dubrow, R. Anal. Chem. 2001, 73, 1207-1212.
47. Srinivasan, K.; Pohl, C.; Avdalovic, N. Anal. Chem. 1997, 69, 2798-2805.
48. Belder, D.; Deege, A.; Husmann, H.; Kohler, F.; Ludwig, M. Electrophoresis 2001, 22, 3813-3818.
49. Verzola, B.; Gelfi, C.; Righetti, P. G. J. Chromatogr. A 2000, 874, 293-303.
50. Lee, K. Y.; Mooney, D. J. Chem. Rev. 2001, 101, 1869-1879.
51. Scott, R. A.; Peppas, N. A. Biomaterials 1999, 20, 1371-1380.
52. Zhan, W.; Seong, G. H.; Crooks, R. M. Anal. Chem. 2002, 74, 4647-4652.
53. Revzin, A.; Russell, R. J.; Yadavalli, V. K.; Koh, W.-G.; Deister, C.; Hile, D. D.; Mellott, M. B.; Pishko, M. V. Langmuir 2001, 17, 5440-5447.
54. Chan-Park, M. B.; Yan, Y.; Neo, W. K.; Zhou, W.; Zhang, J.; Yue, C. Y. Langmuir 2003, 19, 4371-4380.
55. Gu, B.; Armenta, J. M.; Lee, M. L. J. Chromatogr. A 2005, 1079, 328-391.

### SUMMARY OF INVENTION

The present invention involves a specially synthesized poly(ethylene glycol) (PEG) functionalized acrylic copolymer and fabrication of biocompatible devices using this copolymer. The copolymer comprises a matrix of ethylene glycol chains with ethylene glycol end groups. The copolymer is suitable for fabrication of any device designed with surfaces that require contact with biomolecules. The surface of the copolymer is nonreactive and resistant to biomolecules. The copolymer as originally formed has a suitable nonreactive surface and the surface does not require further treatment to render it nonreactive. Biomolecules include molecules such as proteins and peptides. Biomolecules also include bioparticles, which include cells, cell fragments, viruses, and the like.

The copolymer is essentially non-reactive to biomolecules or is functionally nonreactive with the biomolecule. This means that the reactivity or adsorption of biomolecules on the surface does not significantly affect the function of the device, so that the function of the device is not materially compromised by device surface reactions with biomolecules. Such surface reactions are inhibited, and in some cases are essentially eliminated.

The copolymer is easy to manufacture and form, making fabrication of devices easier, faster and cheaper. The copolymer can be easily molded as it is being formed, and the finished copolymer is easily shaped by conventional techniques, such as cutting, machining, etching, and the like. In addition, separate copolymer shapes can be easily bonded to each other with covalent bonds. The covalent bonding involves placing the surfaces together and polymerizing unreacted residues in the surface to form covalent bonds between the surfaces.

The copolymer may also be covalently bonded in like manner to other chemically compatible polymers (e.g., acrylates). These features combined allow for manufacture and shaping of the copolymer for essentially any device that has surfaces that contact biomolecules.

As a specific example, substrates and cover plates of microfluidic devices can be formed in shapes where the copolymerization was not completed, and then bonding the shapes by placing them together and reacting the non-reacted monomer residues that still exist in the surfaces to form covalent bonds. The shaping can also include other suitable methods, such as molding (e.g., soft lithography) etching, and machining (e.g., using a CO₂ laser).

The copolymer comprises the reaction product of Compound A and Compound B. Compound A has the formula:

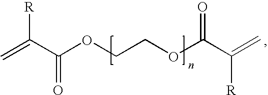

and Compound B has the formula

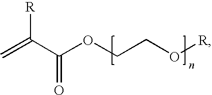

where the R groups are the same or different and are selected from hydrogen, and alkyl groups with 4 carbons or less,
where n is the same or different and is greater than 3.

In compound A, n is greater than three, with best results believed to result when n is between 3 and 10. In Compound B, n is 3 or greater than 3 with the upper limit determined by practical considerations of fabrication, viscosity properties, and the like. Compound B where n is as high as 100 is believed to be suitable.

The R groups are hydrogen or low molecular-weight alkyl groups, with larger alkyl groups being less desirable. Alkyl groups up to 4 carbons are believed to be suitable. Preferred are hydrogen, methyl, and ethyl groups. Exemplary compounds, as more fully described below are poly(ethylene glycol) diacrylate (PEGDA) as Compound A, and poly(ethylene glycol) methyl ether methacrylate (PEGMEMA) as Compound B.

Compound A and Compound B may also include other end groups, or groups in the chain, that do not materially compromise the function and properties of the final copolymer, and the device made from the copolymer.

The copolymer may be the reaction product of only Compound A and Compound B, or may include other compounds to improve the properties of the copolymer, such as strength. These compounds can be added in an amount so as to not substantially compromise the nonreactive surface properties of the copolymer. An exemplary additive is methyl methacrylate (MMA), and related compounds (Compound C) represented by the formula;

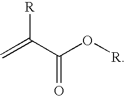

where R is the same as defined above.

The copolymer can be fabricated into any suitable biomedical device. Examples include devices for separation of proteins by electrophoresis, micro-reactors, biosensors, microfluidic flow cytometers, microfluidic multi-dimensional separation devices, biological sample trays, biological assay slides, arrays, and holders, and the like. The copolymer may also be used in body implants, artificial organs, and the like.

Compound A, Compound B, and any other suitable additives are copolymerized using known polymerizing systems to form acrylate polymers. Exemplary processes include those that use a chemical initiator to initiate the copolymerization reaction. Suitable initiators include photoinitators and thermal initiators.

As an example of the invention, planar micro capillary electrophoresis (μCE) devices were fabricated from this copolymer with the typical cross pattern to facilitate sample introduction. In comparison to most common polymeric materials, the photopolymerization fabrication process for the copolymer was of the soft lithography type, and both patterning and bonding could be completed within 10 min. In a finished microdevice, the cover plate and patterned substrates were linked through strong covalent bonds. Additionally, because of the copolymer's resistance to adsorption, microfluidic devices fabricated from the copolymer could be used without surface modification to separate proteins and peptides. Separations of fluorescein isothiocyanate-labeled protein and peptide samples were accomplished using the μCE microchips. Separation efficiencies as high as 4.7×10⁴ plates were obtained in less than 40 s with a 3.5-cm separation channel, yielding peptide and protein peaks that were symmetrical.

### BRIEF DESCRIPTION OF DRAWINGS

FIG. 1 is schematic diagram showing fabrication of microchips using the PEG-functionalized copolymer; (A) Channel fabrication, (B) cover plate fabrication.

FIGS. 2A and 2B are schematic diagrams showing voltage schemes for μCE experiments; (A) Injection, (B) separation. (1) Sample reservoir, (2) sample waste reservoir, (3) buffer reservoir, and (4) buffer waste reservoir.

FIG. 3 shows monomers used in the synthesis of the PEG-functionalized acrylic copolymer.

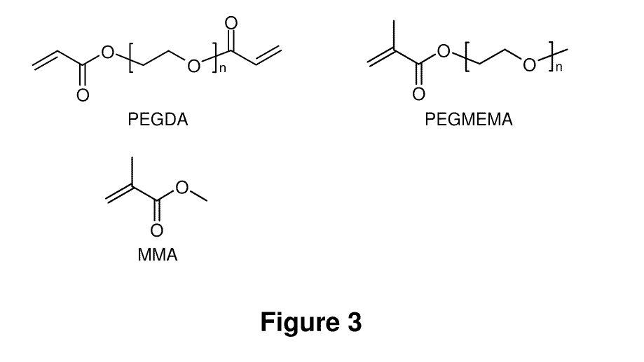

FIG. 4 is a graph showing UV-visible spectra of Acrylite OP-1, PEG-functionalized acrylic copolymer, and Acrylite FF.

FIGS. 5A to 5D are graphs showing electrophoresis of proteins: (A) μCE of FITC-HSA. (B) μCE of a FITC-labeled protein mixture containing (1) β-lactoglobulin A, (2) thyroglobin, (3) myoglobin, and (4) HSA. (C) μCE of a FITC-labeled peptide mixture containing (1) GY, (2) FGGF, (3) WMDG, and (4) GGYR. (D) μCE of FITC-labeled ovalbumin tryptic digest, (1) particle or bubble, (2) FITC.

### DETAILED DESCRIPTION

### Example

### Experimental Section

### Materials

2,2′-Dimethoxy-2-phenylacetophenone (DMPA), poly(ethylene glycol) methyl ether methacrylate (PEGMEMA, MW˜1100), poly(ethylene glycol) diacrylate (PEGDA, MW˜258), and methyl methacrylate (MMA, 99%) were purchased from Aldrich (Milwaukee, Wis., USA). Na₂CO₃ and anhydrous Na₂SO₄ were obtained from Fisher Scientific (Fair Lawn, N.J., USA). Fluorescein isothiocyanate (FITC) was ordered from Invitrogen (Carlsbad, Calif., USA). Myoglobin, porcine thyroglobulin, β-lactoglobulin A, FITC-conjugated human serum albumin (FITC-HSA), gly-tyr (GY), phe-gly-gly-phe (FGGF), trp-met-asp-phe (WMDG) and phe-phe-tyr-arg (GGYR) were purchased from Sigma (St. Louis, Mo., USA). Ovalbumin tryptic digest was ordered from MicroSolv (Eatontown, N.J., USA). Pre-cleaned microscope slides with dimensions of 75×50×1 mm and 75×25×1 mm were obtained from Fisher Scientific (Pittsburgh, Pa., USA) and Hardy Diagnostics (Santa Maria, Calif., USA), respectively. The 18.2 MΩ-cm deionized water used in this work was collected from a Milli-Q UF Plus water purification system (Millipore, Billerica, Mass., USA), and the buffer solution used throughout the experiments was 10 mM TRISMA-HCl (Tris-HCl) at pH 8.7, which was filtered using 0.2 μm syringe filters (Pall Gelman Laboratory, Ann Arbor, Mich., USA). Unless specifically noted, all chemicals were used without further purification.

Purification of PEGDA 258

To remove the impurities and the inhibitor in PEGDA 258, 50 mL of the diacrylate and 30 mL of aqueous saturated Na₂CO₃ solution were added to a 250-mL separation funnel and shaken vigorously. The funnel was then placed on a ring stand until phase separation occurred, and the lower liquid layer (i.e., Na₂CO₃ solution) was removed. This washing procedure was repeated two additional times, followed by thoroughly rinsing with 50 mL of deionized water to remove any Na₂CO₃ residue. Two aliquots of 50 mL methylene chloride were then used to extract PEGDA 258 from the water. The methylene chloride extracts were combined and desiccated with anhydrous Na₂SO₄. After filtering through filter paper (0.2-micron pore size), the methylene chloride solvent was removed using a rotary evaporator.

Fabrication of Microchips

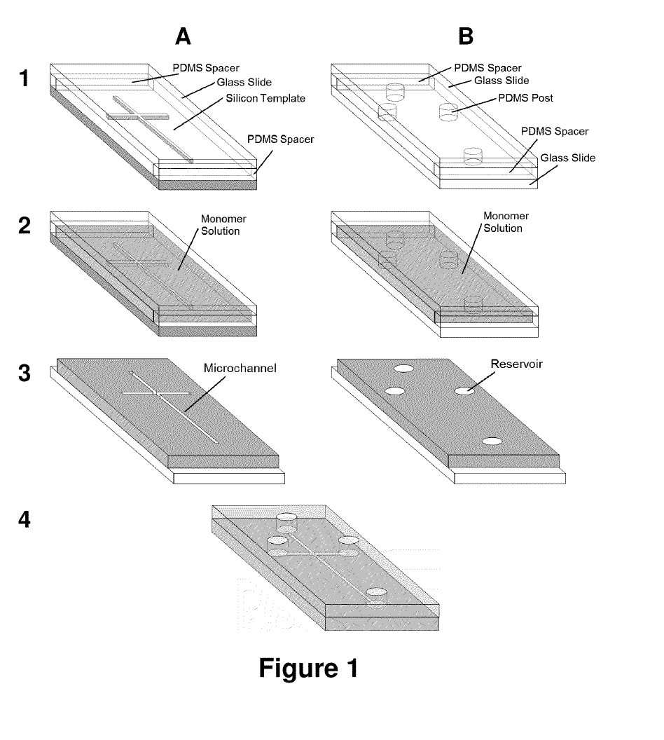

As shown in FIG. 1, step A1, the channel pattern on a silicon template^{26,27} was enclosed using a piece of glass microscope slide and two PDMS spacers. In step A2, the PEG-functionalized monomer solution, which contained 85 wt % PEGDA 258, 12 wt % PEGMEMA 1100, 3 wt % MMA, and DMPA (0.1 wt % PEGDA 258+PEGMEMA 1100+MMA), was introduced into the silicon wafer-glass form. In step A3, the assembly was placed 60 cm below an EC-5000 Dymax UV curing system (8 mW/cm²), cured for 16 s, and cooled down to room temperature. The silicon template was then carefully removed using a razor blade. To fabricate a cover plate, a glass form was constructed using two glass slides and two PDMS spacers. Four PDMS posts, which served as reservoir molds, were sandwiched between the slides (FIG. 1, step B1). After introducing the monomer solution into the glass form (FIG. 1, step B2), the monomer was cured for 17 s using the same procedure as in step A3, and the cover slide was carefully removed with a razor blade (FIG. 1, step B3). Finally, the semi-cured cover plate was peeled off the supporting glass slide using a razor blade, and placed on top of the semi-cured substrate bearing the channel pattern (FIG. 1, step 4). After removing bubbles trapped between the substrates using silicon-wafer-handling tweezers, the temporarily bonded microdevice was placed 15 cm below the UV curing lamp (50 mW/cm²) and exposed to UV light for 5 s. During exposure, the methacryl and acryl residues in both substrates formed covalent bonds, which permanently linked the substrates together.

Because the UV radiation attenuated when passed through the prepolymer solution, different layers experienced different polymerization rates during photoreaction. Therefore, the resulting polymer substrates had different mechanic strength at each layer and the microchip had a tendency to deform. To flatten the chip, it was sandwiched between two glass slides immediately after UV exposure and placed under a weight (2.4 kg) for 3-4 min. The overall microfabrication time was less than 10 min.

UV/VIS Spectrometry

UV-VIS spectra of the PEG-functionalized acrylic copolymer were recorded using a Beckman DU 530 UV/VIS spectrophotometer (Beckman Coulter, Fullerton, Calif.). The percent transmittance was measured from 200 to 600 nm, and the sampling interval was 5 nm.

Electroosmotic Flow Measurements

The current monitoring method was used to measure the electroosmotic flow (EOF) in the microchannel.³⁸ Before measurement, the channel was thoroughly rinsed with deionized water and 20 mM Tris-HCl buffer (pH 8.7). Following rinsing, 20 mM Tris-HCl buffer (pH 8.7) was introduced into the channel. A reservoir at one end of the channel was emptied and replaced with 10 mM Tris-HCl buffer (pH 8.7). The total volume of buffer at each reservoir was kept the same. A PS-350 high-voltage supply unit (Stanford Research Systems, Sunnyvale, Calif., USA) was used to provide the operating voltage, and the variation in current was recorded using a PCI-1200 data acquisition board (National Instruments, Austin, Tex., USA) controlled with a custom LabView 61 software program (National Instruments).

Preparation of FITC-Labeled Protein and Peptide Solutions

Except for FITC-conjugated HSA, which was purchased from Sigma-Aldrich, each protein/peptide sample was dissolved in 10 mM sodium bicarbonate (pH=9.2). The final concentration of each protein and peptide was adjusted to 1 mg/mL and 2 mM, respectively. Protein solution (2 mL) was then thoroughly mixed with 6 mM FITC in DMSO (final molar ratio of protein to FITC was 1:3). For peptides, 200 μL of each peptide solution were mixed with 50 μL of 6 mM FITC in DMSO. All protein/peptide-FITC solutions were placed in the dark for 2 days at room temperature before use.

Separation of Proteins and Peptides Using μCE Chips

Laser induced fluorescence detection and data acquisition were used as previously reported.³⁹ The sampling rate for data collection was 100 Hz.

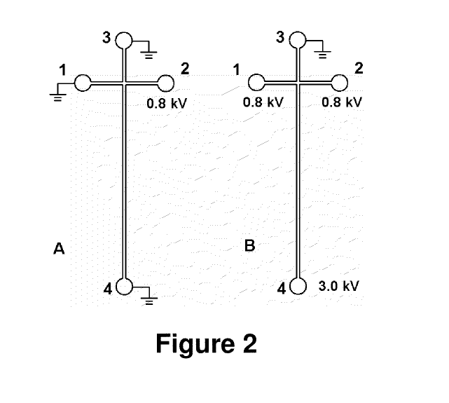

Voltages were applied to the reservoirs using PS-300 and PS-350 high-voltage supply units (Stanford Research Systems). The two voltage supplies were connected using a home-built switching circuit board. As shown in FIG. 2, during injection, reservoirs 1, 3, and 4 were grounded, and reservoir 2 was maintained at +0.8 kV. During separation, reservoirs 1 and 2 were at +0.8 kV, reservoir 3 was grounded, and reservoir 4 was set at +3.0 kV.

### Results and Discussion

Microfabrication Using PEG-Functionalized Acrylic Copolymer

Protein-adhesion-resistant polymers including poly(ethylene oxide) (PEO),⁴⁰⁻⁴³ PAAm,⁴⁴ poly(N-hydroxyethylacrylamide) (PHEAm),⁴⁵ poly(N,N′-dimethylacrylamide) (PDMA),⁴⁶ polyvinylpyrrolidone (PVP),⁴⁷ poly(vinyl alcohol) (PVA),⁴⁸ hydroxyethyl cellulose (HEC),⁴⁹ and hydroxypropylmethylcellulose (HPMC),⁴⁹ have been previously used in analytical separation media as coating materials. Unfortunately, most protein-adhesion-resistant polymers, which are linear hydrophilic polymers, have poor physical and optical properties. Moreover, they tend to absorb water and swell significantly in aqueous solution. Therefore, these polymers cannot be directly used in fabrication of microdevices.

Poly(ethylene glycol) (PEG), the low-molecular-weight form of PEO, has been widely used in tissue engineering⁵⁰ and pharmaceutical applications⁵¹ because of its resistance to protein adsorption, biocompatibility, and low toxicity to cells. Derivatives of PEG such as photocurable PEG-functionalized acrylates/methacrylates, are especially valuable because they can be employed in the preparation of microstructures and polymeric materials with anti-biofouling properties through photolithography. Recently, Zhan et al.⁵² reported the fabrication of PEG hydrogel-based microreactors and microsensors within microfluidic channels. Revzin et al.⁵³ patterned PEGDA, PEG dimethacrylate, and PEG tetraacrylate hydrogel microstructures on silicon or glass substrates using conventional photolithography. Chan-Park et al.⁵⁴ used UV embossing or UV imprint lithography to fabricate high-aspect-ratio microchannels and microcups using PEGDA. Gu et al.⁵⁵ photosynthesized a poly(polyethylene glycol methyl ether acrylate-co-polyethylene glycol diacrylate) rigid monolith for size-exclusion chromatography that gave complete recovery of both acidic and basic proteins. It seems apparent from these studies that copolymers of PEG-functionalized acrylates/methacrylates should have physical and chemical properties suitable for fabrication of microfluidic devices that are resistant to protein adsorption.

All available PEGDA materials from Aldrich were investigated [i.e., PEGDA 258 (Mₙ˜258), PEGDA 575 (Mₙ˜575), and PEGDA 700 (Mₙ˜700)] and found that the homopolymers of all three were transparent to visible light. However, PEGDA 258 showed the best mechanic strength; the other homopolymers were soft and fragile. Unfortunately, preliminary tests indicated that photopolymerization of PEGDA 258 with 0.1% DMPA was very fast, and the reaction could be completed within 6 s. Therefore, it was very difficult to use the protocol outlined in FIG. 1 to fabricate microfluidic devices using neat PEGDA 258. Instead of the neat crosslinker, copolymers containing PEGMEMA, MMA, and PEGDA 258 were used in the fabrication of microdevices. Three PEGMEMA materials, i.e., PEGMEMA 300 (Mₙ˜300), PEGMEMA 475 (Mₙ˜475), and PEGMEMA 1100 (Mₙ˜1100), can be purchased from Aldrich.

It was observed in microchip capillary electrophoresis (μCE) of FITC-labeled human serum albumin (HSA) that the protein resistance of the copolymer increased with an increase in PEG units in the PEGMEMA. The best results were obtained when using PEGMEMA 1100. Furthermore, while increasing the amount of MMA in the copolymer improved the mechanical strength of the copolymer, protein adsorption also increased since more hydrophobic character was introduced on the copolymer surface. After balancing protein resistance and mechanical strength, a formulation was arrived at of 85 wt % PEGDA 258, 12 wt % PEGMEMA 1100, 3 wt % MMA, and DMPA (0.1 wt % of PEGDA 258+PEGMEMA 1100+MMA) for fabrication of microdevices.

As described in the Experimental Section, PDMS was used for spacers and reservoir molds during fabrication. Interestingly, it was observed that monomers at the interface of the copolymer and PDMS were not polymerized as rapidly as the bulk polymer, and a liquid film always remained between the PDMS and the cured copolymer. It is possible that the oxygen absorbed in the PDMS substrate inhibited the photopolymerization at the PDMS-prepolymer interface and the monomers within regions close to the PDMS surface could not fully react. Therefore, a liquid film containing unreacted monomers formed after the reaction. To prevent the liquid film from entering the microchannel and forming a plug in the following UV bonding step (FIG. 1, step B4), it was carefully removed using laboratory vacuum (FIG. 1, step B3). After bonding, the substrates could not be separated.

Since PEGDA 258 is the major component of the copolymer, its impurities (possibly carboxylic acid, acid chloride, anhydride, or others) significantly affect the final surface properties of the copolymer. It was observed that μCE devices fabricated from copolymer containing unpurified PEGDA 258 had relatively strong EOF, which could decrease migration or even reverse the migration direction of FITC-HSA. Additionally, EOF was irreproducible. In comparison, when deacidified PEGDA 258 was used, EOF was reduced and reproducible results were obtained during electrophoresis of FITC-HSA.

Physical Properties of PEG-Functionalized Acrylic Copolymer

Because the PEG-functionalized acrylic copolymer was highly cross linked, swelling in aqueous solution was greatly reduced. 10 mM Tris buffer (pH 8.7) was introduced into a microchannel fabricated from the copolymer and no significant channel deformation was observed after 24 h. Hydrocarbons such as hexane, heptane, and cyclohexane did not cause swelling of the copolymer. However, alcohols such as methyl, ethyl and isopropyl alcohol could slowly swell the copolymer and seal the microchannel after 10 h.

Similar to other acrylic plastics, the PEG-functionalized acrylic copolymer could be machined using a CO₂ laser (Universal Laser Systems, Scottsdale, Ariz., USA), producing a stable, smooth, transparent surface. In comparison, when using the CO₂ laser to machine thermally-bonded PMMA devices, delamination was observed at the bonding interface along the cutting path.

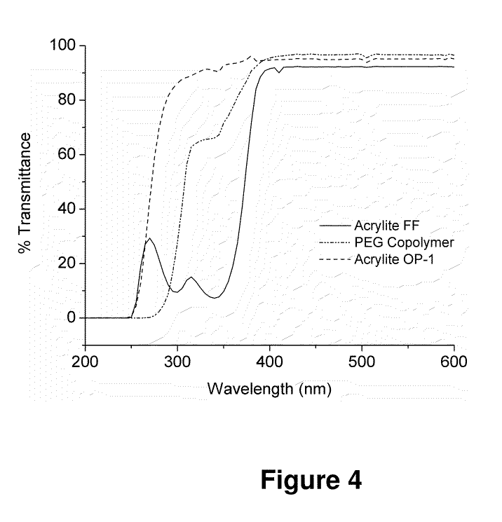

A UV-visible spectrum of the PEG-functionalized copolymer is shown in FIG. 4. In comparison to Acrylite OP-1 and Acrylite FF (Cyro, West Paterson, N.J., USA), which are commercially available PMMA substrates used in microfabrication, the copolymer has the highest transmittance (over 90%) in the range of 395-600 nm. From 290 to 395 nm, the optical transparency of the copolymer is slightly inferior to that of Acrylite OP-1; however, it is still higher than that of Acrylite FF. The transmittance of the copolymer rapidly decreases below 290 nm, and light below 270 nm is completely absorbed by the copolymer. These results indicate that sensitive visible laser-induced fluorescence detection can be applied to microdevices fabricated using the copolymer. Furthermore, UV sources that emit UV radiation with wavelengths in the range of 320-390 nm can be utilized to initiate polymerization in the copolymer microchannels.

The EOF mobility in microchannels fabricated from the PEG-functionalized copolymer was (6.3±0.2)×10⁻⁵ cm²·V⁻¹·s⁻¹ (% CL=95%, average of three measurements) under conditions used in this study for separation of proteins and peptides, and the EOF direction was from anode to cathode. This EOF mobility is higher than that of PEG-grafted PMMA microchannels,²⁶ which may be due to the impurities in PEGMEMA 1100.

Separation of Proteins and Peptides

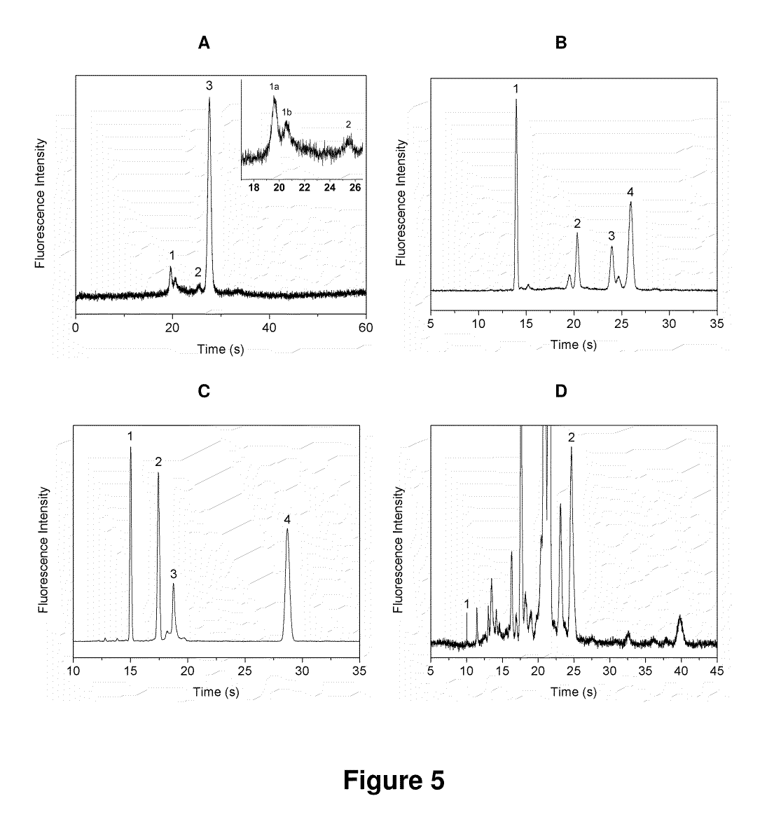

FITC-labeled human serum albumin (FITC-HSA), which readily adsorbs on common polymeric substrates such as PDMS and PMMA, was used to evaluate the adsorption properties of capillary electrophoresis microchips (μCE) fabricated using the PEG-functionalized copolymer. As shown in FIG. 5A, FITC-HSA was resolved into three peaks. The small doublet (peaks 1a and 1b) could be aggregates of HSA, fragments of FITC-HSA, or HSA with multiple FITC tags; peak 2 is FITC. The major peak (peak 3) has a symmetrical profile (asymmetry factor=1.03), which indicates that FITC-HSA has little interaction with the surface of the PEG-functionalized copolymer.

FIG. 5B shows an electrophoretic separation of a protein mixture containing four proteins. FITC-labeled thyroglobin co-migrated with the doublet fragment of FITC-HSA (peak 1, FIG. 5A) under the experimental conditions used. FIG. 5C shows the separation of a peptide mixture containing FITC-labeled GY, FGGF, WMDG, and GGYR using the polymeric μCE device. Performance data determined from the protein and peptide separations are summarized in Tables 1 and 2, respectively. An FITC-labeled tryptic digest of ovalbumin was also separated using the microdevice (FIG. 5D). Since not all digested ovalbumin fragments were effectively labeled with FITC, the peptide mixture does not appear to be as complex as when UV absorption detection is used.

The separation results reported here indicate that the protein/peptide separation performance of the μCE devices fabricated using the PEG-functionalized copolymer without additional surface modification is superior to that of the uncoated μCE devices made from common polymers such as PDMS²³ and PMMA,²⁶ and similar to the performance of the polymeric devices grafted with protein-resistant materials.^{26, 27} However, it should be noted that low-density impurities, which were introduced into the polymer matrix through copolymerization of PEGMEMA 1100 with the other monomers, and were not homogeneously distributed on the polymer surface, yielded inhomogeneous EOF that broadened protein and peptide peaks and decreased separation performance. Further improvement in performance should be possible using highly purified reagents.

### CONCLUSIONS

A protein-adhesion-resistant PEG-functionalized acrylic copolymer was synthesized and used in the fabrication of microfluidic devices. In the testing experiments, proteins and peptides were electrophoretically separated using μCE microchips constructed from the copolymer. It should be noticed that due to the protein resistance feature of the copolymer, the microchips can be used immediately after microfabrication without further permanent surface treatment or dynamic surface coating, which greatly simplifies the fabrication process of microfluidic devices for protein and peptide analysis. Furthermore, the microfabrication procedure for the PEG-functionalized copolymer is similar to PDMS. Researchers familiar with soft lithography³¹ should readily learn to work with the PEG-functionalized copolymer. Finally, although only μCE microchips were demonstrated in our work, the copolymer can be utilized as substrates in the fabrication of disposable polymeric microdevices such as micro-reactors, biosensors, microfluidic flow cytometers, microfluidic multi-dimensional separation devices, or conventional biomedical devices, and find many applications in a broad range of areas such as biology, medicine, and proteomic studies, etc.

While this invention has been described with reference to certain specific embodiments and examples, it will be recognized by those skilled in the art that many variations are possible without departing from the scope and spirit of this invention, and that the invention, as described by the claims, is intended to cover all changes and modifications of the invention which do not depart from the spirit of the invention.

TABLE 1
Column efficiencies and migration
time reproducibilities for proteins

| | Peak 1 | Peak 2 | Peak 3 | Peak 4 |
|---|---|---|---|---|
| Total plates* | 2.0 × 10⁴ | 2.2 × 10⁴ | 3.8 × 10⁴ | 1.8 × 10⁴ |
| RSD (%)* | 0.8% | 1.4% | 1.6% | 2.9% |

*Data were calculated from three consecutive runs.

TABLE 2
Column efficiencies and migration
time reproducibilities for peptides

| | Peak 1 | Peak 2 | Peak 3 | Peak 4 |
|---|---|---|---|---|
| Total plates* | 4.2 × 10⁴ | 3.7 × 10⁴ | 4.7 × 10⁴ | 2.6 × 10⁴ |
| RSD (%)* | 1.5% | 0.7% | 1.7% | 0.9% |

*Data were calculated from three consecutive runs.

What is claimed is:

1. Copolymer comprising the reaction product of Compound A having the formula: 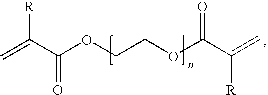
and Compound B having the formula 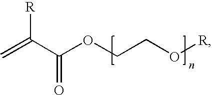
where the R groups are the same or different and are selected from hydrogen, and alkyl groups with 4 carbons or less,
where n is the same or different and is greater than 3.

2. A copolymer as in claim 1 wherein n in Compound A is between 3 and 10.

3. A copolymer as in claim 1 wherein the R groups are selected from H, —CH₃, and —CH₂CH₃

4. A copolymer as in claim 1 that is the reaction product of poly(ethylene glycol) diacrylate (PEGDA) and poly(ethylene glycol) methyl ether methacrylate (PEGMEMA).

5. A copolymer as in claim 1 that is the reaction product of Compound A, Compound B, and additionally Compound C, Compound C having the formula;

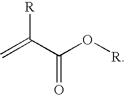

6. A copolymer as in claim 5 wherein Compound C is methyl methacrylate (MMA).

7. A device comprising at least one surface designed for contact with biomolecules where the surface is functionally nonreactive with the biomolecules, the surface comprising a copolymer that is the reaction product of Compound A having the formula: 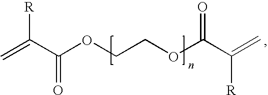
and Compound B having the formula 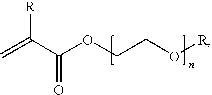
where the R groups are the same or different and are selected from hydrogen, and alkyl groups with 4 carbons or less,
where n is the same or different and is greater than 3.

8. The device of claim 7 wherein the device comprises at least two shapes comprising the copolymer with adjacent surfaces covalently bonded together.

9. The device of claim 7 wherein the device is for separation of protein by electrophoresis, a micro-reactor, a biosensor, a microfluidic flow cytometer, a microfluidic multi-dimensional separation device, a biological sample tray, biological assay slide, sample array, or holder

10. The device of claim 7 wherein the device is a conventional biomedical device.

11. The device of claim 7 wherein the device is an implant or artificial organ.

12. A method for manufacturing a device that has a surface that is functionally nonreactive with biomolecules, the method comprising forming and shaping a copolymer to form the surface, the copolymer comprising the reaction product of Compound A having the formula: 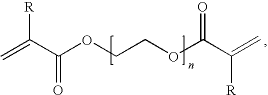
and Compound B having the formula 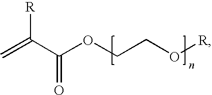
where the R groups are the same or different and are selected from hydrogen, and alkyl groups with 4 carbons or less,
where n is the same or different and is greater than 3.

13. The method of claim 12 wherein the shaping comprises one or more of molding during the copolymerizing, etching, covalent bonding of separate copolymer shapes, and machining.

14. The method of claim 12 wherein the forming comprises bonding together surfaces of partially copolymerized forms of Compound A and Compound B, where the surfaces are placed together and unreacted residues in the surface are polymerized to form covalent bonds between the surfaces.

15. The method of claim 12 wherein the forming of the copolymer involves use of a photo initiator, or a thermal initiator.
